(19) United States
(12) Patent Application Publication
(10) Pub. No.: US 2020/0260648 A1
(43) Pub. Date: Aug. 20, 2020

(54) SUPPORT ASSEMBLY FOR DUAL ROTARY RAKING MACHINE

(71) Applicant: Agri Systems, Inc., Chowchilla, CA (US)

(72) Inventors: Brendan J. Brooks, Chowchilla, CA (US); Taylor Brady, Yuba City, CA (US)

(73) Assignee: Agri Systems, Inc., Chowchilla, CA (US)

(21) Appl. No.: 16/790,668

(22) Filed: Feb. 13, 2020

Related U.S. Application Data
(60) Provisional application No. 62/805,907, filed on Feb. 14, 2019.

(51) Int. Cl. A01D 89/00

(52) U.S. Cl. CPC A01D 89/004; A01D 89/008

(57) ABSTRACT

The present invention provides provide adjustable dual rotary raking machines in which the lateral positions of the rotors and rakes may be moved while in use without stopping operation. The present invention also provides adjustable dual rotary raking machines which are suitable for collecting prunings from agricultural orchards or vineyards having low hanging branches. The present invention further provides adjustable dual rotary raking machines which may be easily collapsed for storage and transport into a small profile that allows multiple options for storing the machines, and does not require special permits to transport the collapsed machines on public roads.

### PRIORITY CLAIM

This application is a non-provisional of and claims the benefit of U.S. Provisional Application No. 62/805,907 filed on Feb. 14, 2019, which is incorporated herein by this reference in its entirety.

### BACKGROUND OF THE INVENTION

### 1. Field of the Invention

The present invention relates to machines for raking and windrowing of materials from agricultural fields including prunings, debris and hay, and more particularly to a support assembly for dual rotary raking machines that allows for the lateral positions of the raking machines to be adjusted during operation as they are being pulled down a row of a field, that prevents low overhanging branches from clogging the raking machines, and that allows for the raking machines to be compactly arranged when not in use for easy storage and transport.

### 2. Description of the Prior Art

A typical rotary hay raking machine includes a carrying structure that is designed to be pulled behind a tractor. The carrying structure supports a rotor having a vertical orientation that is connected to a plurality of outwardly extending raking tools. As the tractor travels down a row, the rotor spins causing the raking tools to collect materials from the ground and deposit them in a windrow for later collection. The carrying structure attaches to the back of a tractor, and linkages are typically used to connect the rotor to a rotating shaft on the tractor to impart rotational movement thereto. One or more support wheels may be provided on the carrying structure below or near the rotor to help carry the weight.

The position of the carrying structure and rotor is ordinarily fixed, and is directly behind the tractor. In some devices the position of the carrying structure and rotor may be set such that it protrudes out at an angle from the back of the tractor, but this position is ordinarily fixed such that the tractor must be stopped in order to move the carrying structure laterally to another (fixed) position. This is usually not necessary since the most common material collected by rotary raking machines is hay from an open field. However, when agricultural materials must be collected from between rows of trees, having the carrier in a fixed position behind the tractor without the ability to move laterally (horizontally/from side to side) may result in leaving behind some materials that are close to the trees, especially if the trees are not evenly planted or spaced.

A typical rotary hay raking machine generally includes a single rotor. However, for wider rows, dual rotors may be provided which rotate in opposite directions so as to deposit the collected materials in a windrow between the two rotors. When in use, the lateral positions of the carrying structures for dual rotors are generally fixed with respect to the tractor, and also fixed with respect to each other, since they are generally mounted to a single large support structure pulled behind a tractor. Thus, without the ability to move laterally, the fixed positions of dual rotor raking machines give them very little flexibility for use in unevenly planted orchards or the like.

Since hay is the most common material collected by rotary raking machines, these machines are typically pulled along rows in an open field. The only guards provided in such machines are pipes or bars at the edges which are designed to prevent workers from accidentally coming into contact with (i.e., walking into) the rakes while in operation. However, when such rotary raking machines are used to collect prunings or debris from underneath trees in the rows of an orchard or vineyard, any low overhanging tree branches or vines could stray into the rakes and cause them to break or become jammed or disabled. Accordingly, existing rotating raking machines are not always suitable for use in collecting prunings or debris from agricultural orchards or vineyards having plants with low hanging branches.

The large supports currently used with dual rotary raking machines also pose significant transportation and storage issues. In existing dual rotary raking machines, each of the two rotor and rake assemblies is designed to be deployed in a horizontal position when in use in a field, and then each one may be rotated ninety degrees to a vertical position for storage and transport. Unfortunately, even when folded up to generally vertical positions, the height and width of these rotor and rake assemblies are still significant. Excessive height limits the types of vehicles and storage sheds that may be used to transport or house the machines, and excessive width (more than 11 or 12 feet) may result in the requirement for special permits to transport the machines on public roads.

It is therefore desirable to provide adjustable dual rotary raking machines in which the lateral positions of the rotors and rakes may be moved while in use without stopping. It is also desirable to provide adjustable dual rotary raking machines which are suitable for collecting prunings from agricultural orchards or vineyards having low hanging branches. It is further desirable to provide adjustable dual rotary raking machines which may be easily collapsed for storage and transport into a small profile that allows multiple options for storing the machines, and does not require special permits to transport the collapsed machines on public roads.

### SUMMARY OF THE INVENTION

Embodiments of the present invention provide support assemblies for dual rotary raking machines in which the support structures for each of the two raking machines are capable of being moved laterally (horizontally/from side to side) while in use. This allows the raking machines to be moved in and out as they travel along a row of trees or vines in order to access areas close to and between the trees or vines of the row. This is accomplished using pivotal mounts for each support structure together with a lateral motion imparting piston. Each support structure has its own separate piston so that each raking machine may be moved independently of the other.

Embodiments of the invention are also provided with one or more additional pistons that are capable of imparting vertical motion to one (or both) of the pivotally mounted raking machine support structures. This facilitates easy storage and transport. In some embodiments, these pistons are used to raise both of the pivotally mounted raking machine support structures from a generally horizontal position to a generally vertical position (90°). In some embodiments, both support structures may be raised and rotated beyond a vertical position by as much as 115°. In other embodiments, a piston is activated to raise the first raking machine support and the raking machine attached thereto upward in the air. The lateral piston of the other raking machine support is then operated to move the other raking machine inward toward a center line between the two raking machines. The lateral piston of the first (raised) raking machine is then operated to also bring it inward toward the center line, such that the two raking machines wind up in a generally stacked configuration, one above the other. This provides a compact arrangement for transportation and storage.

In some embodiments, the yoke which supports the two mounting structures is provided with a first lateral hinge and piston on one side which allows a portion of the yoke supporting the first mounting structure on that side to be rotated ninety degrees from a generally horizontal position to a generally vertical position. This rotation brings the first mounting structure and the raking machine attached thereto to a vertical position as well. In these embodiments, the yoke is also provided with another hinge and piston on the opposite side which allows a portion of the yoke supporting the second mounting structure on the opposite side, and the raking machine attached thereto, to be rotated inward, underneath the first mounting structure and raking machine. This also provides a compact arrangement for transportation and storage.

In embodiments of the invention, one or more movable panels may optionally be provided above each raking machine. In these embodiments, a first panel is provided which may be moved into a horizontal position that extends out and over the top of the outer half of the raking machine. This panel provides an upper shield for the rakes on the outer half of the machine as they are raking, preventing low-hanging branches or other items from reaching or dropping down into the rakes from above while the machine is in use. When not in use, this panel may be rotated upward approximately ninety degrees to a generally vertical position, allowing easy access to the rakes from above for cleaning and maintenance. A similar panel may also be provided on the second raking machine of the set.

In some embodiments, an optional second smaller movable panel may also be provided to cover some or all of the inner half of the raking machine. This second panel may also be moved from a generally horizontal shielding position while the machine is in use, to a generally vertical position for cleaning and maintenance. The second panel preferably covers only a forward portion of the inside of the raking machine to prevent interference with the rakes as they are pointing downward. The rakes are generally raised upward for approximately the last one quarter (¼) of their circular trip around the rotor so as to let go of any collected material and leave it in a windrow, so no overhead protection is ordinarily necessary during this portion of the raking process.

In one aspect of the invention, a cross member for supporting a dual rotary raking machine is provided comprising an elongated member having a first end section hingedly attached to a central section and an opposite end section hingedly attached to the central section, a first piston attached to the first end section and to the central section, a second piston attached to the second end section and to the central section, wherein operation of each of the first and second pistons causes each of the first and second end sections to rotate between a generally horizontal position of about zero degrees and an upward position of up to about one hundred fifteen degrees.

In another aspect of the invention, the cross member may further comprise a first support arm pivotally mounted to the first end section, and a second support arm pivotally mounted to the second end section, a third piston attached to the first end section and to the first support arm, a fourth piston attached to the second end section and to the second support arm, wherein operation of each of the third and fourth pistons causes each of the first and second arms to rotate laterally along a horizontal plane between an inward retracted position and an outward extended position.

In another aspect of the invention, the inward retracted position may be as much as about five degrees from a centerline, and the outward extended position may be as much as about forty five degrees from the centerline.

In another aspect of the invention, the cross member may further comprise a first locking mechanism between the first end section and the central section, and a second locking mechanism between the second end section and the central section for temporarily holding the end sections in place relative to the central section.

In another aspect of the invention, the cross member may further comprise a first joint on the first support arm, a second joint on the second support arm, a first shock absorber provided across the first joint, and a second shock absorber provided across the second joint.

In another aspect of the invention, the cross member may further comprise a first raking machine mounted to the first support arm, and at least one first shielding bar attached to and extending perpendicularly out from the first support arm above a forward portion of the first raking machine, and a second raking machine mounted to the second support arm, and at least one second shielding bar attached to and extending perpendicularly out from the second support arm above a forward portion of the second raking machine.

In another aspect of the invention, the cross member may further comprise a first raking machine mounted to the first support arm, and at least one first shielding plate attached to and extending out from the first support arm above a forward portion of the first raking machine, and a second raking machine mounted to the second support arm, and at least one second shielding plate attached to and extending out from the second support arm above a forward portion of the second raking machine.

In another aspect of the invention, a dual rotary raking machine may be provided comprising a horizontally oriented elongated cross member having a centrally located bracket for attachment to the back of a vehicle; a first extension having a first end attached to one end of the cross member using a first hinge, and a second end pivotally attached to a first support arm; a first piston having one end attached to the cross member and an opposite end attached to the first extension for imparting motion to the first extension around the first hinge; a second extension having a first end attached to an opposite end of the cross member using a second hinge, and a second end pivotally attached to a second support arm; a second piston having one end attached to the cross member and an opposite end attached to the second extension for imparting motion to the second extension around the second hinge; a first rotary raking machine pivotally attached to the first support arm; a third piston having one end attached to the first extension and an opposite end attached to the first support arm for imparting lateral motion to the first support arm; a second rotary raking machine pivotally attached to the second support arm; and a fourth piston having one end attached to the second extension and an opposite end attached to the second support arm for imparting lateral motion to the second support arm.

In another aspect of the invention, the dual rotary raking machine may further comprise a first locking mechanism between the first extension and the cross member, and a second locking mechanism between the second extension and the cross member for temporarily holding the extensions in place relative to the cross member.

In another aspect of the invention, the dual rotary raking machine may further comprise a first joint on the first support arm, a second joint on the second support arm, a first shock absorber provided across the first joint, and a second shock absorber provided across the second joint.

In another aspect of the invention, the dual rotary raking machine may further comprise at least one first shielding bar attached to and extending perpendicularly out from the first support arm above a forward portion of the first rotary raking machine, and at least one second shielding bar attached to and extending perpendicularly out from the second support arm above a forward portion of the second rotary raking machine.

In another aspect of the invention, the dual rotary raking machine may further comprise at least one first shielding plate attached to and extending out from the first support arm above a forward portion of the first rotary raking machine, and at least one second shielding plate attached to and extending out from the second support arm above a forward portion of the second rotary raking machine.

In another aspect of the invention, operation of each of the first and second pistons of the dual rotary raking machine causes each of the first and second extensions to rotate between a generally horizontal position of about zero degrees and an upward position of up to about one hundred fifteen degrees.

In another aspect of the invention, operation of each of the first and second pistons of the dual rotary raking machine causes each of the first and second extensions to rotate from a generally horizontal position to a generally vertical position.

In another aspect of the invention, operation of each of the third and fourth pistons of the dual rotary raking machine causes each of the first and second arms to rotate laterally along a horizontal plane between an inward retracted position and an outward extended position.

In another aspect of the invention, the inward retracted position may be as much as about five degrees from a centerline, and the outward extended position may be as much as about forty five degrees from the centerline.

In another aspect of the invention, the dual rotary raking machine may further comprise a first handle on the first rotary raking machine and a second handle on the second rotary raking machine for adjusting the vertical heights thereof.

In another aspect of the invention, a method for collapsing a dual rotary raking machine for storage or transport comprises the steps of activating the first piston to raise the first extension upward to an angle of between ninety degrees and one hundred fifteen degrees; and activating the second piston to raise the second extension upward to an angle of between ninety degrees and one hundred fifteen degrees.

It is therefore an object of the present invention to provide adjustable dual rotary raking machines in which the lateral positions of the rotors and rakes may be moved while in use without stopping or interrupting operation.

It is also an object of the present invention to provide adjustable dual rotary raking machines which are suitable for collecting prunings from agricultural orchards or vineyards having low hanging branches.

It is also an object of the present invention to provide adjustable dual rotary raking machines which may be easily collapsed for storage and transport into a small profile that allows multiple options for storing the machines, and does not require special permits to transport the collapsed machines on public roads.

Other objects of the invention will be apparent from the detailed descriptions and the claims herein.

### BRIEF DESCRIPTION OF THE DRAWINGS

FIG. 1 is a perspective view of an embodiment of the present invention showing a pair of raking machines and support structures, and shields in a raised position.

FIG. 2 is a perspective view of the embodiment of FIG. 1 showing the shields in a lowered position.

FIG. 3 is an inside sectional view of the embodiment of FIG. 1 showing detail of one of the raking machines and the shields in a raised position.

FIG. 4 is an inside sectional view of the embodiment of FIG. 1 showing the shields in a raised position.

FIG. 5 is a top view of the embodiment of FIG. 1 showing the shields in a raised position.

FIG. 6 is a top view of the embodiment of FIG. 1 showing the shields in a lowered position.

FIG. 7 is a rear view of the embodiment of FIG. 1 showing the shields in a raised position.

FIG. 8 is a rear view of the embodiment of FIG. 1 showing the shields in a lowered position.

FIG. 9 is a top view of the embodiment of FIG. 1 showing hydraulic lines.

FIG. 10 is a rear view of an embodiment of a yoke of the present invention.

FIG. 11 is a rear view of an alternative embodiment of a yoke of the present invention.

FIG. 12 is a rear view of an alternative embodiment of a yoke of the present invention.

FIG. 13 is a perspective view of an alternative embodiment of the present invention showing a pair of raking machines and support structures.

FIG. 14 is front elevational view of the embodiment of FIG. 13.

FIG. 15 is a top view of the embodiment of FIG. 13.

FIG. 16 is another top view of the embodiment of FIG. 13 showing horizontal rotation of one support arm.

FIG. 17 is another top view of the embodiment of FIG. 13 showing a different horizontal rotation of one support arm.

FIG. 18 is front elevational view of the embodiment of FIG. 13 showing both support arms rotated upward to generally horizontal positions.

FIG. 19 is another front elevational view of the embodiment of FIG. 13 showing both support arms rotated upward and further inward than FIG. 18.

FIG. 20 is a top view of the embodiment of FIG. 13 showing exemplary hydraulic lines.

### DETAILED DESCRIPTION

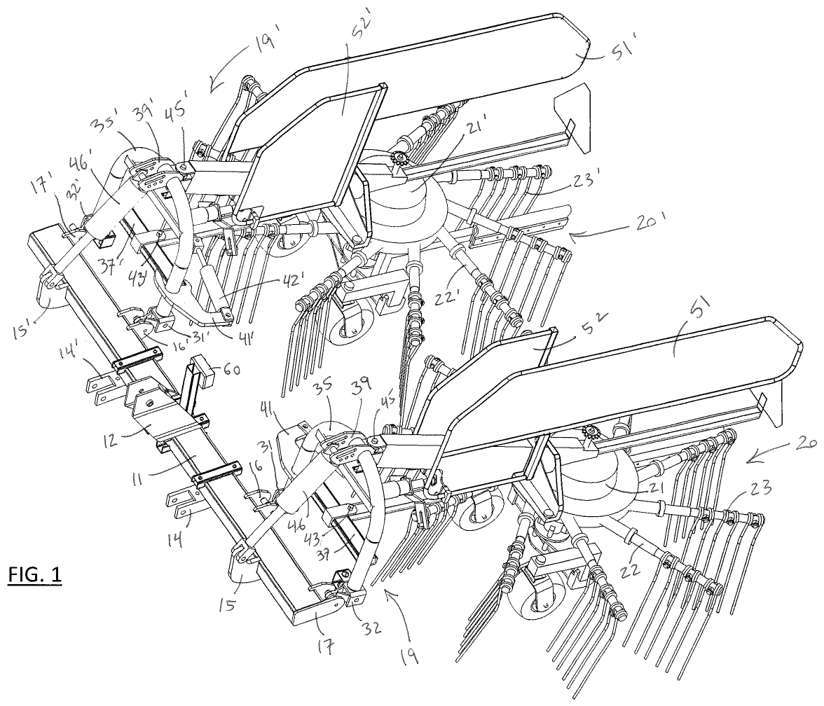

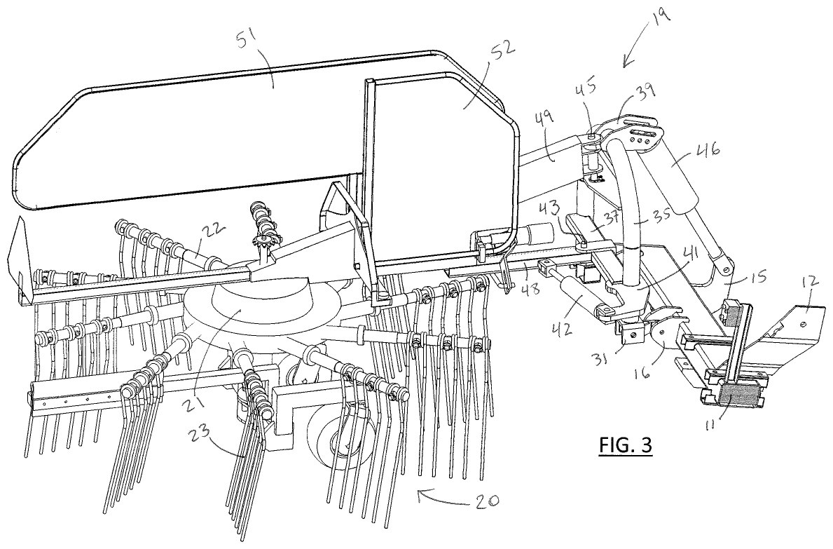

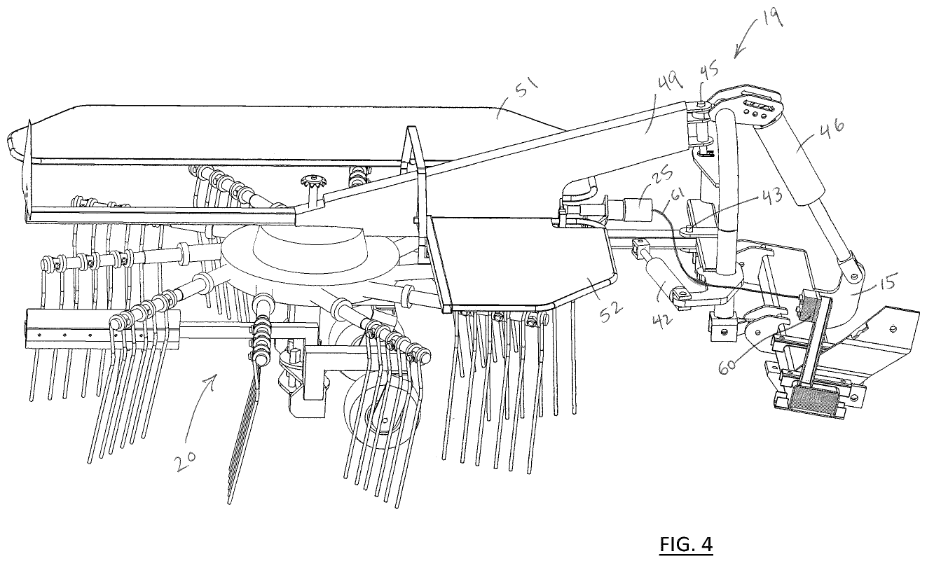

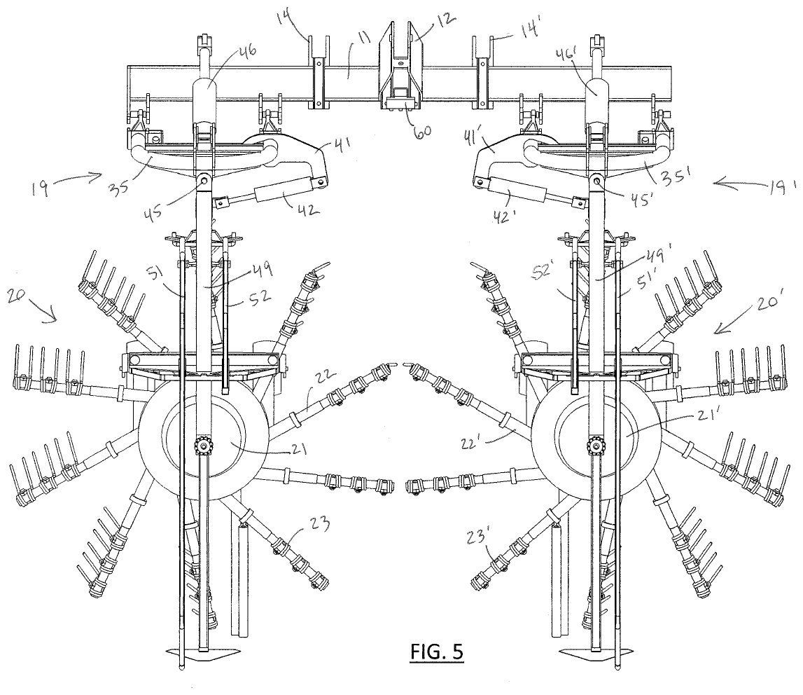

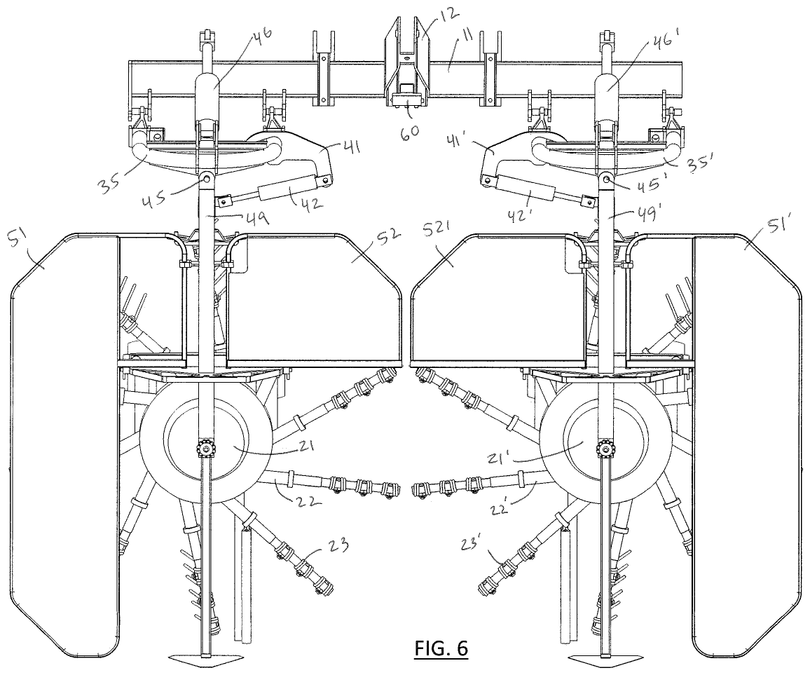

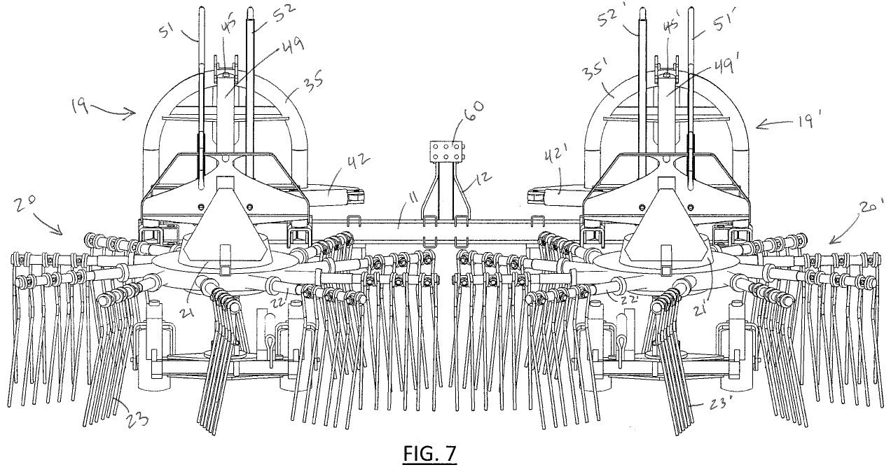

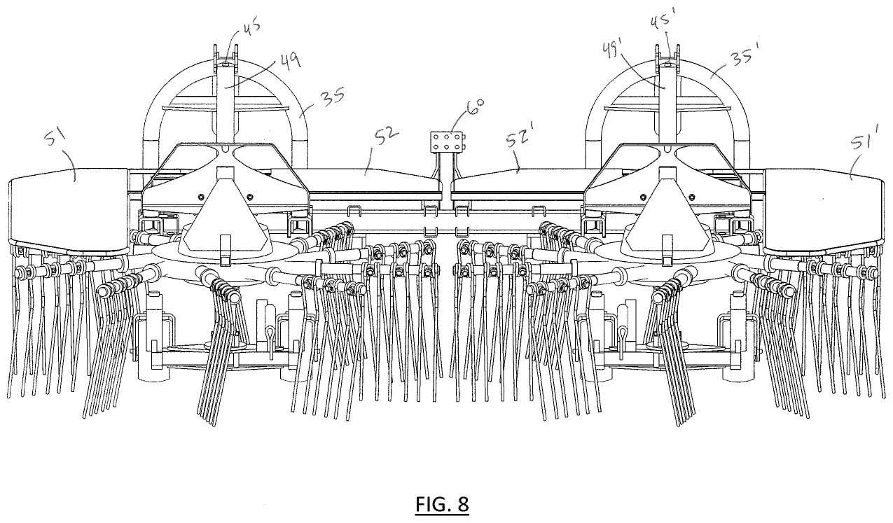

Referring to the drawings wherein like reference characters designate like or corresponding parts throughout the several views, and referring particularly to FIGS. 1-8, it is seen that the illustrated embodiment of the invention includes an elongated cross bar or yoke 11 that is designed to be attached to the rear of a vehicle, such as a tractor, using a central bracket 12, and side mounts 14 and 14′. A pair of support structures (generally 19 and 19′) are provided at either end of yoke 11, supporting, respectively, a pair of rotatable raking machines (generally 20 and 20′). Each raking machine 20, 20′ includes a rotor 21, 21′ attached to a plurality of arms 22, 22′, with each arm having a movable rake 23, 23′ at an end thereof.

It is to be appreciated that in most embodiments, the support structures 19, 19′ and raking machines 20, 20′ are generally mirror images of each other, such that references characters in the drawings provided herewith that include an apostrophe or prime symbol (′) identify a structure on one of these assemblies that corresponds to the same or similar structure on the other assembly that is identified with the same number but without the apostrophe or prime symbol. Accordingly, for simplicity, much of the following description will refer to the non-prime reference characters of one of the assemblies, it being appreciated that these descriptions also apply to the corresponding structures identified with prime reference characters on the other mirror image assembly.

In the illustrated embodiment of FIGS. 1-8, raking machine 20 is supported by a structure which may include one or more lower mounts 31, 32 pivotally attached to brackets 16, 17 on yoke 11. Mounts 31, 32 may support a bar 35 that may be bow-shaped. Bar 35 is designed to support upper and lower pivots (43, 45) which allow the raking machine 20 to move in a lateral direction. In the illustrated embodiment, a lower cross-bar 37 and an upper bracket 39 are provided, where lower cross bar 37 may support a lower pivot 43, and upper cross bar 39 may support an upper pivot 45. Lower pivot 43 may be pivotally attached to a lower support 48 of the raking machine, and upper pivot 45 may be pivotally attached to an upper support 49 of the raking machine. An arm 41 may be attached at one side of bar 35, and piston 42 may be attached between arm 41 and lower support 48.

When piston 42 is activated, it causes the raking machine supports 48 and 49 to move in a lateral direction around upper pivot 45 and lower pivot 43. Extending piston 42 causes supports 48 and 49 to move out and away from a centerline between the two assemblies 19, 19′; and contracting piston 42 causes supports 48 and 49 to move in and toward (and sometimes across) the centerline. The lateral motion imparted by piston 42 to supports 48 and 49 causes the entire attached raking machine 20 to move in a lateral direction. Piston 42 may be operated using hydraulics or pneumatics, thereby allowing the lateral position of the raking machine 20 to be changed at any time during operational use.

Another bracket 15 may be provided on the back end of yoke 11 between brackets 16 and 17, and another piston 46 may be provided between bracket 15 and bracket 39. In these embodiments, when piston 46 is activated, it causes bar 35 and the entire support structure 19 to move in a vertical direction, bringing the raking machine 20 with it. Contracting piston 46 causes mounts 31 and 32 to pivot on brackets 16 and 17, thereby raising structure 19 including without limitation bar 35, mounts 48 and 49, and raking machine 20, in an upward direction. In some embodiments, only one piston 46 is provided (i.e., there is no corresponding piston 46′ for the other assembly).

For storage or transportation purposes, piston 46 may first be activated to raise structure 19 and the first raking machine 20; then piston 42 may be activated to move the first raking machine 20 laterally inward toward and across the center line. Then, piston 42′ may be activated to move the second raking machine 20′ inward toward and across the center line, bringing the second raking machine 20′ to a position that is generally below the first raking machine 20.

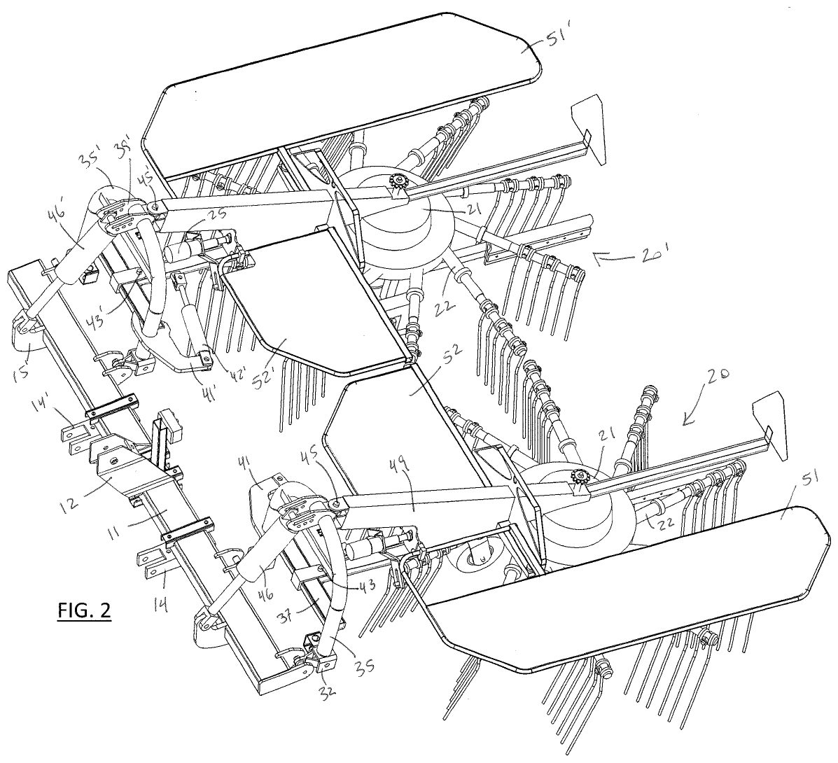

Embodiments of the invention may also be provided with one or more shielding plates 51, 51′ and optional additional shielding plates 52, 52′. The shielding plates may be hingedly attached to the mounting structures 19, 19′ and may be moved from a generally vertical orientation for storage or transport, as shown in FIGS. 1, 3, 5 and 7 to a generally horizontal position during use, as shown in FIGS. 2, 4, 6 and 8. In the illustrated embodiment, large plates 51, 51′ are provided for positioning above the outside edges of the raking machines 20, 20′. When lowered to the horizontal position, plates 51, 51′ are designed to provide a shield that covers the rakes 23, 23′ as they rotate around the outside portion (approximately half) of each raking machine. This helps prevent low overhanging branches or other similar obstructions from becoming entangled with the moving rakes as the raking machine is pulled through an orchard or vineyard.

An optional smaller plate 52, 52′ may also be provided for positioning above a forward portion of the inside edges of the raking machines 20, 20′. When lowered to the horizontal position, plates 52, 52′ provide additional shielding that covers rakes 23, 23′ as they rotate through a forward portion of each raking machine.

Each of plates 51, 51′, 52 and/or 52′ may be operated independently of each other. It is to be appreciated that in some environments, it may not be necessary to lower any of plates 51, 51′, 52 and/or 52′ to their horizontal positions if there are no overhanging branches or similar obstructions to contend with; alternatively, it may be appropriate to lower all of the plates (51, 51′, 52 and 52′) where there is thick underbrush. It is to be appreciated that in some environments, it may only be necessary or appropriate to lower the outermost plate (e.g. 51′) to horizontal, or to only lower the two plates (51′, 52′) of one of the two raking machines (e.g. 20′) which may be operating adjacent to trees having low-hanging branches, and not lower the two plates (51, 52) of the other raking machine (e.g. 20) since the other raking machine may not be operating near any trees.

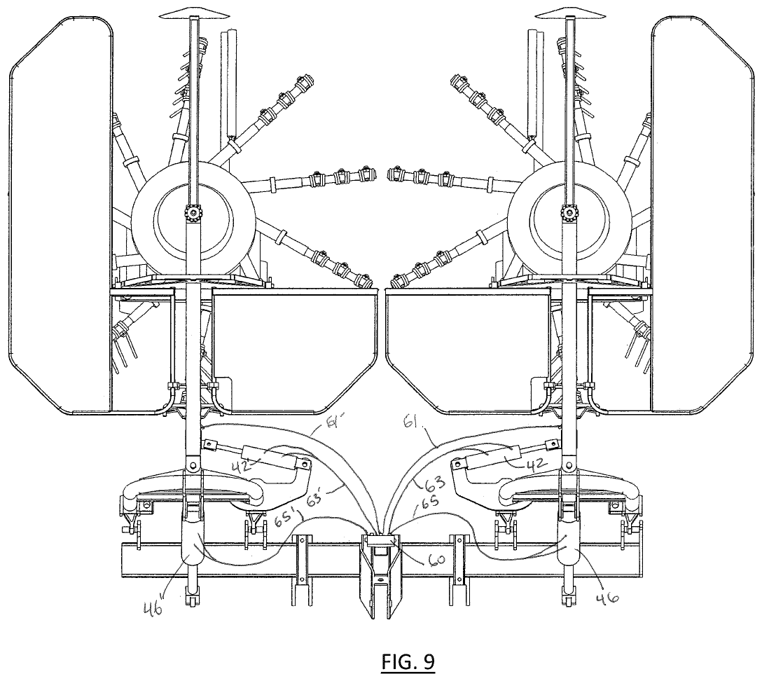

Referring to FIG. 9, it is seen that in embodiments of the invention, a hydraulic system may be employed to impart motion to the rotating rake assembly and to the pistons. In these embodiments, a hydraulic hub 60 may be provided on yoke 11, and a set of operator controls may be provided near the driver seat and/or in the cab of the vehicle or tractor. A first set of lines 61, 61′ may be provided extending to the ends 25, 25′ of rotatable shafts in order to impart rotational movement to the rotary raking machines. A second set of lines 63, 63′ may be provided extending to pistons 42, 42′ to impart lateral motion thereto. A third set of lines 65 may be provided extending to piston 46 to impart vertical motion thereto. In optional embodiments, another third set of lines 65′ may be provided extending to piston 46′ to also impart vertical motion thereto. It is to be appreciated that these hydraulic lines have not been illustrated in FIGS. 1-8 for simplicity.

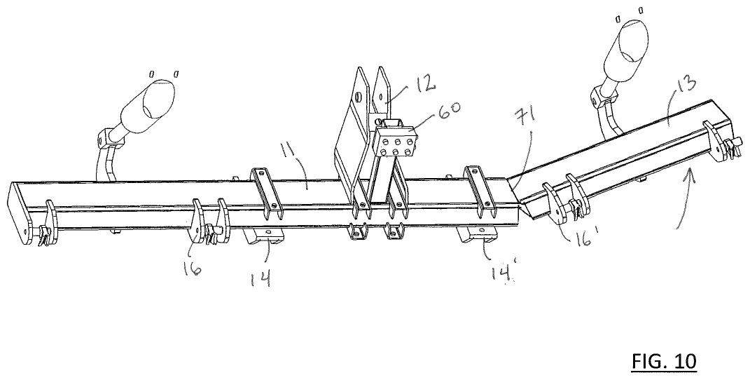

In the embodiments illustrated in FIGS. 10-12, yoke 11 may be provided with one or more hinges which allow one or both of the supports 19, 19′ (and their respective raking machines 20, 20′) to be rotated upward or inward for storage and/or transport. In these embodiments, a first hinge 71 may be provided on one side of yoke 11 between central bracket 12 and one of side mounts 14 or 14′. Hinge 71 extends horizontally across the top of yoke 11, allowing the portion 13 of yoke 11 outside of the hinge 71 to rotate or pivot upward as shown in FIG. 10 by as much as ninety degrees or more. This movement also rotates the associated support (19, 19′) and raking machine (20, 20′) upward. Hinge 71 may be located on either side of yoke 11 between central bracket 12 and one of side mounts 14 or 14′. A hydraulic piston or other motion imparting device may be provided to operate hinge 71.

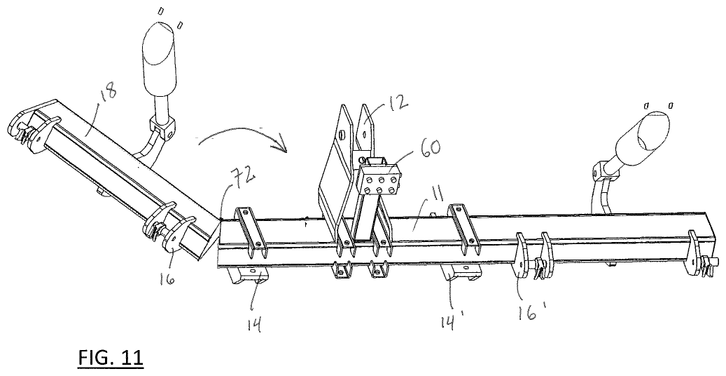

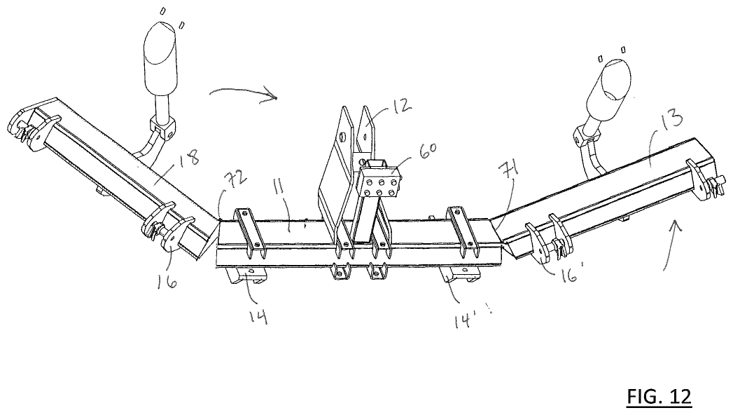

A second hinge 72 may also be provided on yoke 11 extending vertically along a side of yoke 11, allowing the portion 18 of yoke 11 outside of the hinge 72 to rotate or pivot inward (laterally) as shown in FIG. 11 by as much as ninety degrees or more. This movement also rotates the associated support (19, 19′) and raking machine (20, 20′) laterally. Hinge 71 may be located on either side of yoke 11 between central bracket 12 and one of side mounts 14 or 14′. A hydraulic piston or other motion imparting device (not shown) may be provided to operate hinge 72. It is to be appreciated that hinges 71 and 72 may be provided independently of each other as shown in FIGS. 11 and 12, or together as shown in FIG. 12.

In use, operation of first hinge 71 rotates section 13 and its associated first support (e.g. 19) and raking machine (20) approximately ninety degrees to a generally vertical position. Then, operation of second hinge 72 brings section 18 and its second associated support (e.g. 19′) and raking machine (20′) inward horizontally underneath the first support and raking machine. The arms 22, 22′ of the raking machines may be rotated slightly so that they may be interleaved to allow for a closer fit. This allows the dual raking machines to be simply and easily compacted into a small and tight profile for easy transport and storage.

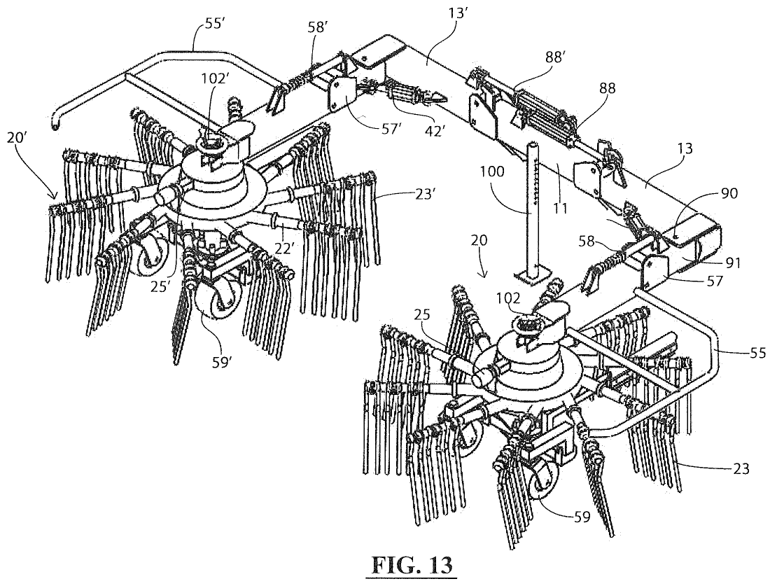

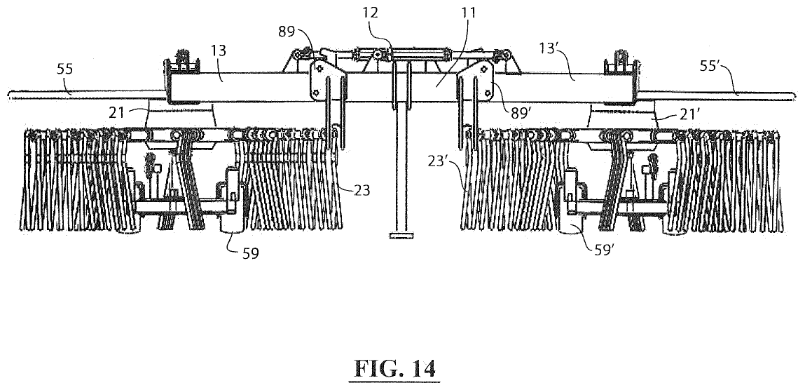

Referring to the embodiment of FIGS. 13-20, it is seen that these illustrated embodiments of the invention include an elongated yoke or cross member 11 that is designed to be attached to the rear of a vehicle with a hydraulic system, such as a tractor, using a central bracket 12, and side mounts 14 and 14′. A pair of support structures (generally 19 and 19′) are provided at either end of cross member 11, supporting, respectively, a pair of rotatable raking machines (generally 20 and 20′). Each raking machine 20, 20′ includes a rotor 21, 21′ attached to a plurality of arms 22, 22′, with each arm having a movable rake 23, 23′ at an end thereof. Each rotor 21, 21′ may be powered by a hydraulic motor 25, 25′ mounted on the rotor hub.

In the illustrated embodiments of FIGS. 13-20, the support structures 19, 19′ and raking machines 20, 20′ are generally mirror images of each other, such that references characters in the drawings provided herewith that include an apostrophe or prime symbol (′) identify a structure on one of these assemblies that corresponds to the same or similar structure on the other assembly that is identified with the same number but without the apostrophe or prime symbol. Accordingly, to the extent that the following description refers to the non-prime reference characters of one of the assemblies, it will be appreciated that these descriptions also apply to the corresponding structures identified with prime reference characters on the other mirror image assembly. However, it is also to be appreciated that in practice, the positions, sizes, lengths and parts of one support structure 19 or one raking machine 20 need not necessarily be the same as the other support structure 19′ or the other raking machine 20′.

In the embodiments of FIGS. 13-20, a central bracket 12 is provided at or underneath cross member 11 such that when bracket 12 is attached to the vehicle, cross member 11 is at an elevated generally horizontal position. This causes each of the support structures 19, 19′ and the associated raking machines 20, 20′ to also be raised or lowered as cross member 11 is raised or lowered. It is possible to adjust the height of the support structures 19, 19′ and associated raking machines 20, 20′ by adjusting the height of the vehicle attachment to cross member 11 using the hydraulic system of the vehicle itself. This will ordinarily allow the cross member 11 to be adjusted through a range of approximately eighteen inches (18″), which range may be larger or smaller depending on the characteristics of the vehicle. In some embodiments, without limitation, the cross member 11 may be raised as much as approximately nine inches (9″) or lowered as much as approximately nine inches (9″) from a starting position. This range of adjustment allows the support structures 19, 19′ and associated raking machines 20, 20′ to be raised or lowered in order to adjust the clearance between the ends of the rake tines 23, 23′ and the surface of the ground over which the raking machines will travel.

The height of each raking machine 20, 20′ may be individually and independently adjusted using a height adjustment screw 82, 82′ provided on each raking machine 20, 20′. Height adjustment screws 82, 82′ may include a handle 102, 102′ in the form of a circular hand grip or other suitable structure for manual operation. This allows each of the two raking machines 20, 20′ to be set at different heights, if desired. For example, and without limitation, in an exemplary situation, the adjustment screw 82 of machine 20 may be adjusted downward, while the other adjustment screw 82′ of machine 20′ may be adjusted upward (or not adjusted at all), thereby causing machine 20 to be in a lower position than machine 20′. In another exemplary situation, without limitation, the adjustment screw 82 of machine 20 may be adjusted upward (or not adjusted at all), while the other adjustment screw 82′ of machine 20′ may be adjusted downward, thereby causing machine 20 to be in a higher position than machine 20′. Other combinations of independent adjustments are also contemplated in different embodiments.

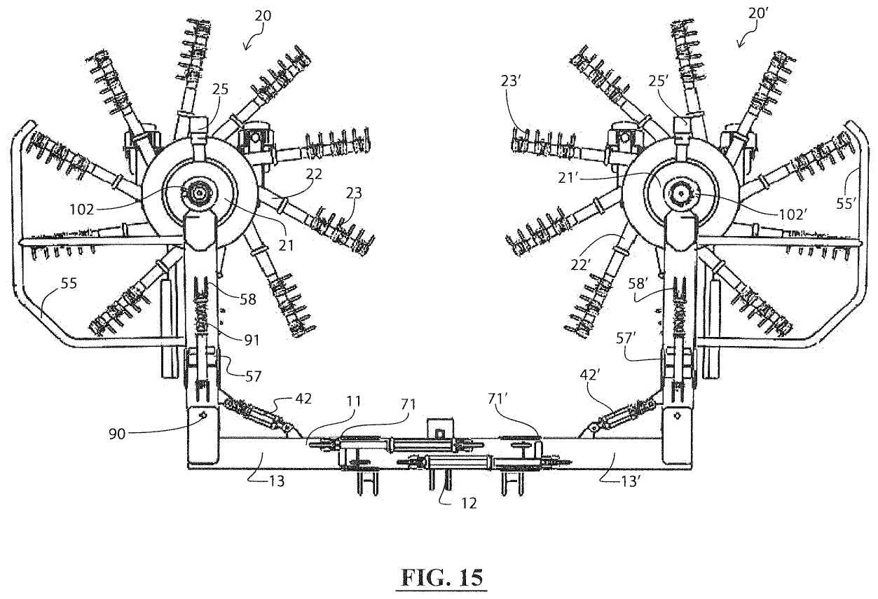

In the embodiments of FIGS. 13-20, two pivots or hinges 71, 71′ may be provided along cross member 11, defining first 13 and second 13′ extensions of cross member 11. Hinges 71, 71′ are ordinarily equidistant from a centerline of cross member 11 because raking machines 20, 20′ are ordinarily mirror images of each other; however, hinges 71, 71′ may be at different locations, depending on differing size(s) (i.e. diameter(s)) of the raking machines 20, 20′. The ends of extensions 13 and 13′ are pivotally attached, respectively, to ends of support arms 91 and 91′. Arms 91, 91′ provide support for, respectively, raking machines 20 and 20′. In a usual starting position, each arm 91, 91′ is positioned horizontally with and generally perpendicular to cross member 11 and to extensions 13, 13′ at a normal (90°) angle. See FIGS. 13 and 15. Pivots 90, 90′ are provided at opposite ends of extensions 13, 13′, at or near where each arm 91, 91′ meets its respective extension 13, 13′, allowing each arm 91, 91′ to rotate along a generally horizontal plane around its respective pivot. A hydraulic cylinder or piston 42, 42′ is provided for each support arm 91, 91′. Each piston 42, 42′ extends laterally between each extension 13, 13′ and its respective arm 91, 91′ for imparting lateral (generally horizontal) motion to arms 91, 91′ so that they may rotate around their respective pivots 90, 90′. Pistons 42, 42′ may be operated using hydraulics or pneumatics, thereby allowing the lateral position of the raking machines 20, 20′ to be changed at any time during operational use (e.g., while the apparatus is in operation traveling over the ground).

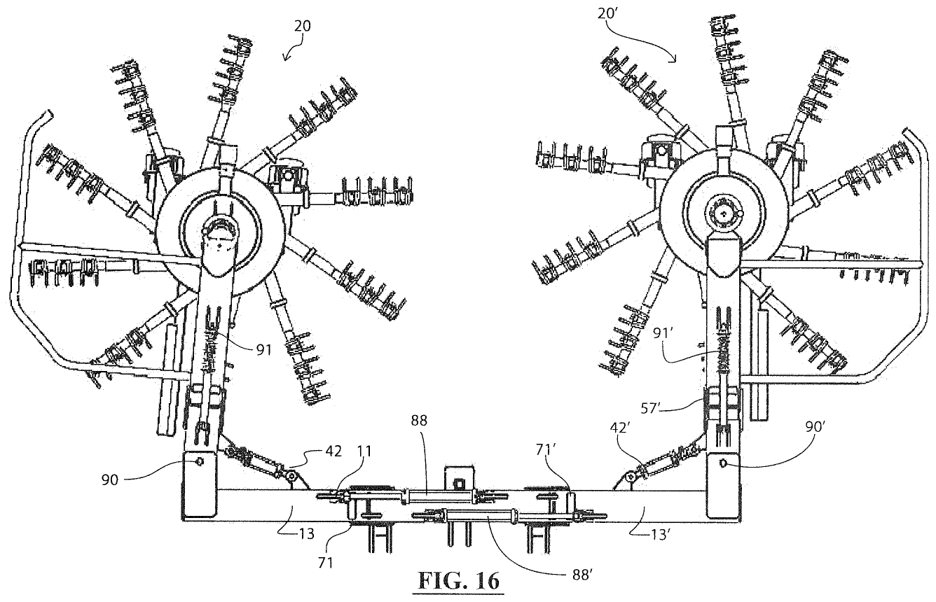

By way of example and without limitation, piston 42 may be contracted to cause arm 91 to rotate horizontally inward from the pivot 90 at the end of extensions 13, which causes raking machine 20 to move inward, as shown in FIG. 16. A stop 86 (not shown) may be provided to limit the distance that support arm 91 may be moved inward, in order to prevent contact between raking machine 20 and the other raking machine 20′. Similarly, piston 42′ may be contracted to cause arm 91′ to rotate horizontally inward around pivot 90′, which causes raking machine 20′ to move inward. Such inward movements of arms 91, 91′ may be made during use of the apparatus in a field, vineyard or orchard, in order to accommodate narrow pathways between rows of vines, trellis structures or trees. It is to be appreciated that the amount of inward movement may be limited by stops 86, 86′ which are designed to prevent the raking machines 20, 20′ from making contact with each other.

Importantly, during operation, pistons 42, 42′ may also be expanded to cause arms 91, 91′ to rotate horizontally outward, causing raking machines 20, 21′ to move outward as well. Pistons 42, 42′ may be operated independently of each other, allowing each arm 91, 91′ to be moved laterally inward or outward without regard to the lateral inward or outward movement of the other arm. This allows each arm 91, 91′ and its associated raking machine 20, 20′ to be positioned independently of the other.

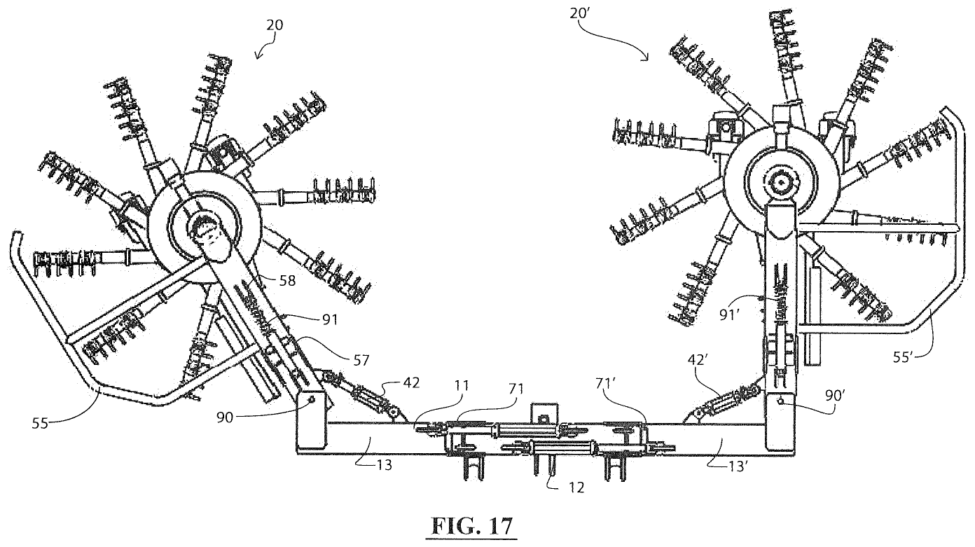

For example, and without limitation, in an exemplary situation, piston 42 attached to arm 19 associated with raking machine 20 may be expanded to move arm 19 outward by, for example, thirty-five degrees (35°), while the other piston 42′ of arm 19′ associated with raking machine 20′ is not moved at all. This exemplary situation is illustrated in FIG. 17. This situation could occur, for example, if the trunks of the trees along one side of the row (where arm 19 is located) are farther away from the center of the row than the trunks of the trees on the opposite side (where arm 19′ is located). The independent movement of arms 91, 91′ allows them to be independently positioned and re-positioned behind the vehicle as the apparatus is pulled through a field or orchard, to accommodate for different widths between rows, or variations in width(s) along rows that may be encountered during operation. In most embodiments, each arm 91 and 91′ may be independently moved inward by up to approximately five degrees (5°) or more, and may be independently moved outward by up to forty-five degrees (45°) or more, depending on the size of the rake assemblies and the limitations of the pistons used, to accommodate different situations while traveling through a field or orchard.

In the embodiments of FIGS. 13-20, it is possible to rotate extensions 13, 13′ upward at hinge pivots 71, 71′ in order to raise arms 91, 91′ and raking machines 20, 20′ upward for transport and storage. In these embodiments, when the raking machines are in use, extensions 13, 13′ extend out from cross arm 11 along a single horizontal axis. During use, extensions 13, 13′ may be kept in place using locking structures 89, 89′. By way of example and without limitation, in the illustrated embodiments, structures 89, 89′ are shown in the form of large removable cotter pins that may be set to keep extensions 13, 13′ in place, although any suitable locking structure may be used. When locked in place, extensions 13, 13′ and cross arm 11 form one continuous yoke with a single central axis.

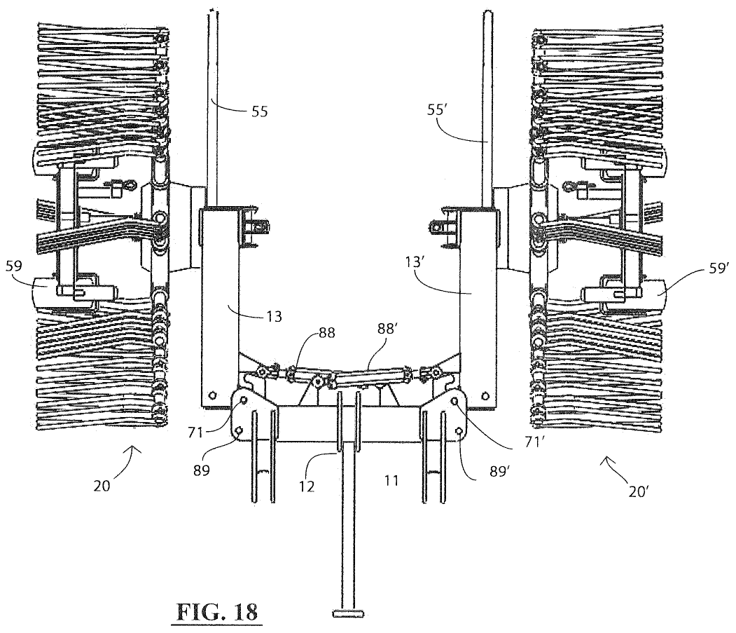

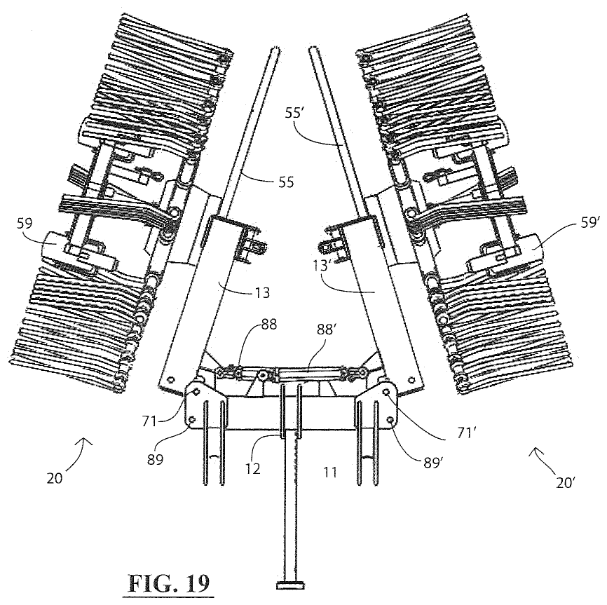

For transportation and storage purposes, locking structures 89, 89′ may be disengaged, and one or both of extensions 13, 13′ may be rotated vertically upward. This rotational movement may be imparted by hydraulic cylinders or pistons 88, 88′ each of which is attached at one end to cross arm 11, and at an opposite end to each of extensions 13, 13′. Pistons 88, 88′ may be operated using hydraulics or pneumatics. Contracting one or both of pistons 88, 88′ causes extensions 13 and/or 13′ to rotate vertically upward along hinge pivots 71, 71′ bringing one or both of extensions 13, 13′ and their attached support arms 91, 91′ and associated raking machines 20, 20′ upward. In the exemplary illustration of FIG. 18, both extensions 13, 13′ have been rotated upward approximately ninety degrees (90°) such that cross arm 11 remains in a horizontal position, but both extensions 13, 13′ are now in a generally vertical position. Pistons 88, 88′ may be further contracted on order to bring extensions 13, 13′ (and arms 19, 19′ and rakes 20, 20′) even closer together (i.e., rotation of more than ninety degrees (90°)) up to as much as approximately 115° or more, depending on the size of the rake assemblies, as shown in FIG. 19. This additional rotation may be imparted to reduce the overall profile of the apparatus in order to aid in transport or storage, in order, for example, to meet highway width restrictions, or to fit into a smaller storage space. Such over-rotation also helps keep the rake assemblies from falling back down to horizontal. It is to be appreciated that expanding pistons 88, 88′ will cause extensions 13 and/or 13′ to rotate downward along hinge pivots 71, 71′ bringing one or both of extensions 13, 13′ (and arms 19, 19′ and rakes 20, 20′) down.

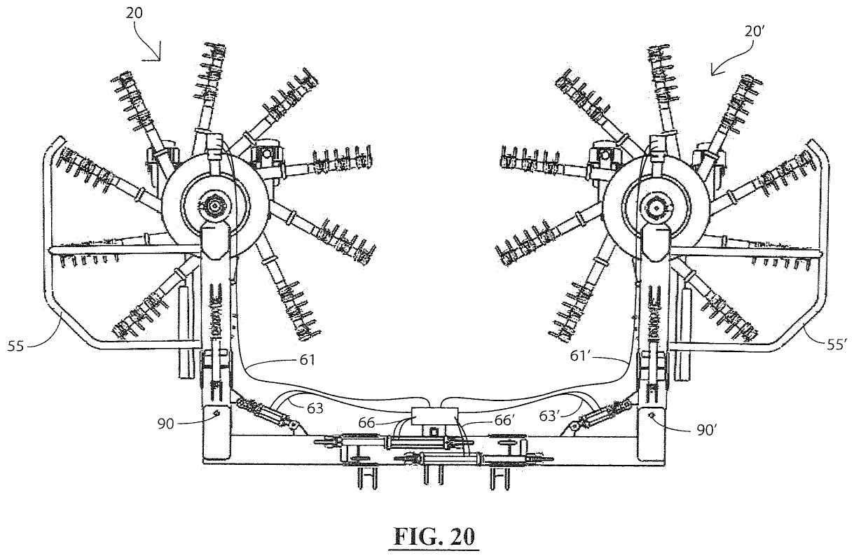

In the embodiments of FIGS. 13-20, a hydraulic system may be employed to impart motion to the rotating rake assembly and to the pistons. In these embodiments, a hydraulic hub 60 may be provided on cross member 11, and a set of operator controls may be provided near the driver seat and/or in the cab of the vehicle or tractor. A first set of lines 61, 61′ may be provided extending from hub 60 to the motors 25, 25′ of rotors 21, 21′ in order to impart rotational movement to the rotary raking machines. A second set of lines 63, 63′ may be provided extending from hub 60 to pistons 42, 42′ to impart lateral motion thereto. See FIG. 20. A third set of lines 66, 66′ may be provided extending from hub 60 to pistons 88, 88′ to impart vertical motion thereto. It is to be appreciated that these hydraulic lines have not been illustrated in FIGS. 13-19 for simplicity.

Embodiments of the invention may also be provided with one or more optional shielding members, rods or bars 55, 55′ that may be attached to the support arms 91, 91′ above a leading, forward outer portion of the raking machines 20, 20′. Bars 55, 55′ may be attached to support arms 91, 91′ at two or more different locations. The forward most bar may extend perpendicularly out from support arms 91, 91′ and then angle back until it is parallel with support arms 91, 91′. A second attachment may be provided between the parallel section of bars 55, 55′ and support arms 91, 91′. The trailing portion of bars 55, 55′ may curl inward toward support arms 91, 91′ toward the rear of the assembly. Bars 55, 55′ are designed to provide a shield in front of and along a portion of the rakes 23, 23′ as they rotate around a forward outside portion (approximately two thirds) of each raking machine 20, 20′. Bars 55, 55′ push low overhanging branches or other similar obstructions out of the way as the raking machines travel forward, to prevent such items from becoming entangled with the moving rakes as the raking machines are pulled through a field, orchard or vineyard.

Embodiments of the invention may also be provided with shock absorbers 58, 58′ which may be provided on arms 91, 91′. In these embodiments, a joint 57, 57′ is provided on each arm 91, 91′ which allows some vertical motion from raking machines 20, 20′ as the support wheels 59 encounter bumps and dips in the row. Shock absorbers 58, 58′ are provided across joints 57, 57′ help minimize the effects of larger bumps and dips encountered by the raking machines 20, 20′. It is to be appreciated that the positions of joints 57, 57′ and the size and positions of shock absorbers 58 58′ need not necessarily be the same for support arm 19 as for support arm 19′. These may be varied depending on the size of the raking machines and the length of the support arms, to provide optimal shock absorption for different sized structures.

In different embodiments, it is to be appreciated that rake arms 22, 22′ may be provided in different lengths to accommodate field rows of different widths, and that longer rake arms 22, 22′ may have more rake tines 23, 23′ whereas shorter rake arms 22, 22′ may have fewer rake tines 23, 23′. Longer rake arms 22, 22′ may be utilized for wider rows to provide a larger radius of coverage for the rotatable raking machines 20, 20′; and shorter rake arms 22, 22′ may be utilized for narrower rows to provide a smaller radius of coverage for the rotatable raking machines 20, 20′. The overall length of the yoke comprising cross member 11 and extensions 13, 13′ may also be longer or shorter to provide clearance to accommodate longer or shorter rake arms 22, 22′. The rake arms of each raking machine 20, 20′ need not necessarily have the same length, although this is ordinarily the case. For example and without limitation, raking machine 20 may have longer arms 22, at the same time that raking machine 20′ has shorter arms 22′, or vice versa. In such examples, extension 13 may be longer than extension 13′, or vice versa.

When not attached to a vehicle or tractor, one or more ground supports 100 may be provided below cross member 11 to support the overall apparatus.

It is to be understood that variations and modifications of the present invention may be made without departing from the scope thereof, and that different combinations of the different features of the several embodiments disclosed herein may be combined together, and that all such possible combinations are within the scope of the invention. For example and without limitation, bars 55, 55′ may be replaced by plates 51, 51′, and vice versa. It is also to be understood that the present invention is not to be limited by the specific embodiments disclosed herein, but only in accordance with the appended claims when read in light of the foregoing specification.

1-8. (canceled)

9. A cross member for supporting a dual rotary raking machine comprising an elongated member having a first end section hingedly attached to a central section and an opposite end section hingedly attached to said central section, a first piston attached to said first end section and to said central section, a second piston attached to said second end section and to said central section, wherein operation of each of said first and second pistons causes each of said first and second end sections to rotate between a generally horizontal position of about zero degrees and an upward position of up to about one hundred fifteen degrees.

10. The cross member of claim 9 further comprising a first support arm pivotally mounted to said first end section, and a second support arm pivotally mounted to said second end section, a third piston attached to said first end section and to said first support arm, a fourth piston attached to said second end section and to said second support arm, wherein operation of each of said third and fourth pistons causes each of said first and second arms to rotate laterally along a horizontal plane between an inward retracted position and an outward extended position.

11. The cross member of claim 10 wherein said inward retracted position may be as much as about five degrees from a centerline, and said outward extended position may be as much as about forty five degrees from said centerline.

12. The cross member of claim 9 further comprising a first locking mechanism between said first end section and said central section, and a second locking mechanism between said second end section and said central section for temporarily holding said end sections in place relative to said central section.

13. The cross member of claim 10 further comprising a first joint on said first support arm, a second joint on said second support arm, a first shock absorber provided across said first joint, and a second shock absorber provided across said second joint.

14. The cross member of claim 10 further comprising a first raking machine mounted to said first support arm, and at least one first shielding bar attached to and extending perpendicularly out from said first support arm above a forward portion of said first raking machine, and a second raking machine mounted to said second support arm, and at least one second shielding bar attached to and extending perpendicularly out from said second support arm above a forward portion of said second raking machine.

15. The cross member of claim 10 further comprising a first raking machine mounted to said first support arm, and at least one first shielding plate attached to and extending out from said first support arm above a forward portion of said first raking machine, and a second raking machine mounted to said second support arm, and at least one second shielding plate attached to and extending out from said second support arm above a forward portion of said second raking machine.

16. A dual rotary raking machine comprising:
a. a horizontally oriented elongated cross member having a centrally located bracket for attachment to the back of a vehicle;
b. a first extension having a first end attached to one end of said cross member using a first hinge, and a second end pivotally attached to a first support arm;
c. a first piston having one end attached to said cross member and an opposite end attached to said first extension for imparting motion to said first extension around said first hinge;
d. a second extension having a first end attached to an opposite end of said cross member using a second hinge, and a second end pivotally attached to a second support arm;
e. a second piston having one end attached to said cross member and an opposite end attached to said second extension for imparting motion to said second extension around said second hinge;
f. a first rotary raking machine pivotally attached to said first support arm;
g. a third piston having one end attached to said first extension and an opposite end attached to said first support arm for imparting lateral motion to said first support arm;
h. a second rotary raking machine pivotally attached to said second support arm; and
i. a fourth piston having one end attached to said second extension and an opposite end attached to said second support arm for imparting lateral motion to said second support arm.

17. The raking machine of claim 16 further comprising a first locking mechanism between said first extension and said cross member, and a second locking mechanism between said second extension and said cross member for temporarily holding said extensions in place relative to said cross member.

18. The raking machine of claim 16 further comprising a first joint on said first support arm, a second joint on said second support arm, a first shock absorber provided across said first joint, and a second shock absorber provided across said second joint.

19. The raking machine of claim 16 further comprising at least one first shielding bar attached to and extending perpendicularly out from said first support arm above a forward portion of said first rotary raking machine, and at least one second shielding bar attached to and extending perpendicularly out from said second support arm above a forward portion of said second rotary raking machine.

20. The raking machine of claim 16 further comprising at least one first shielding plate attached to and extending out from said first support arm above a forward portion of said first rotary raking machine, and at least one second shielding plate attached to and extending out from said second support arm above a forward portion of said second rotary raking machine.

21. The raking machine of claim 16 wherein operation of each of said first and second pistons causes each of said first and second extensions to rotate between a generally horizontal position of about zero degrees and an upward position of up to about one hundred fifteen degrees.

22. The raking machine of claim 16 wherein operation of each of said first and second pistons causes each of said first and second extensions to rotate from a generally horizontal position to a generally vertical position.

23. The raking machine of claim 16 wherein operation of each of said third and fourth pistons causes each of said first and second arms to rotate laterally along a horizontal plane between an inward retracted position and an outward extended position.

24. The raking machine of claim 23 wherein said inward retracted position may be as much as about five degrees from a centerline, and said outward extended position may be as much as about forty five degrees from said centerline.

25. The raking machine of claim 16 further comprising a first handle on said first rotary raking machine and a second handle on said second rotary raking machine for adjusting the vertical heights thereof.

26. A method for collapsing the dual rotary raking machine of claim 16 for storage or transport comprising the steps of:
a. activating said first piston to raise said first extension upward to an angle of between ninety degrees and one hundred fifteen degrees; and
b. activating said second piston to raise said second extension upward to an angle of between ninety degrees and one hundred fifteen degrees.
